(19) United States
(12) Patent Application Publication
(10) Pub. No.: US 2012/0243887 A1
(43) Pub. Date: Sep. 27, 2012

(54) TONER TRANSPORTATION DEVICE, TONER CASE, IMAGE FORMING APPARATUS, AND METHOD OF DETECTING REMAINING AMOUNT OF TONER

(75) Inventors: Koji Murata, Osaka (JP); Tatsuhiko Yoshii, Osaka (JP); Naoki Mizutani, Osaka (JP); Takeshi Fujimura, Osaka (JP); Naoki Yamane, Osaka (JP)

(73) Assignee: Kyocera Mita Corporation, Osaka (JP)

(21) Appl. No.: 13/427,429

(22) Filed: Mar. 22, 2012

(30) Foreign Application Priority Data
Mar. 22, 2011 (JP) 2011-062007

(51) Int. Cl. G03G 15/08; G03G 13/08

(52) U.S. Cl. 399/27

(57) ABSTRACT

A toner transportation device includes a toner case and a drive section. The toner case includes a main body that contains toner, a discharge port located in the main body and allowing toner to pass therethrough, and a transportation unit rotatably positioned in the main body for transporting the toner toward the discharge port. The drive section includes a driving unit that drives the transportation unit, a detection unit that detects rotation of the transportation unit and outputs a rotation number detection signal, and a control unit that estimates an amount of toner remaining in the toner case based on an accumulated number of times the rotation number detection signal has been outputted from the detection unit.

### INCORPORATION BY REFERENCE

This application is based upon and claims the benefit of priority from the corresponding Japanese Patent application No. 2011-062007, filed Mar. 22, 2011, the entire contents of which is incorporated herein by reference.

### BACKGROUND

The present disclosure relates to a toner transportation device that supplies toner to a developing unit, a case for containing the toner, an image forming apparatus equipped with the toner transportation device and the toner case, and a method of detecting the remaining amount of toner.

Today, in electrophotographic image forming apparatuses, toner is supplied from a developing unit to an electrostatic latent image formed on the surface of a photoconductor drum or the like to perform a developing process. Toner used in such developing processes is supplied to the developing unit from the toner case, for example, a toner container.

As the above-described developing process is repeatedly performed, the amount of toner in the toner container decreases. When the toner runs out, the toner container needs to be replaced. In order to identify the time when the toner container needs to be replaced, typical image forming apparatuses are equipped with structures that detect or calculate the amount of toner remaining in the toner container. For example, a known structure uses a magnetic permeability sensor to detect changes in magnetic permeability in the toner container due to a reduction in the amount of toner. Another known structure uses an optical sensor to detect changes in light transmittance in the toner container due to a reduction in the amount of toner. There is yet another known method in which the amount of consumed toner is calculated in view of the number of dots of developed images, and the remaining amount of toner in the toner container is estimated in view of the calculated toner consumption amount.

Using the method in which light transmittance in the toner container is detected using an optical sensor, there is a possibility of the occurrence of detection errors due to contamination or the like of the toner container. The structure wherein magnetic permeability in the toner container is detected using a magnetic permeability sensor is not applicable to non-magnetic toner. In addition, there is a possibility of the occurrence of detection errors owing to variations in magnetic force. Using the method in which the remaining amount of toner in the toner container is estimated in view of the number of dots of developed images, the remaining amount of toner is indirectly estimated in view of the number of dots. Accordingly, errors between the estimated remaining amount of toner and the actual remaining amount of toner tend to occur, thereby making it difficult to reliably estimate the remaining amount of toner.

### SUMMARY

According to an embodiment of the present disclosure, a toner transportation device is provided including a toner case and a drive section. The toner case includes a main body that contains toner, a discharge port that is provided in the main body and allows the toner to pass through the discharge port, and a transportation unit rotatably provided in the main body and transports the toner toward the discharge port. The drive section includes a driving unit that drives the transportation unit, a detection unit that detects rotation of the transportation unit and outputs a rotation number detection signal, and a control unit that estimates a remaining amount of the toner in the toner case in view of the accumulated number of times the rotation number detection signal has been output from the detection unit.

A toner case according to another embodiment of the present disclosure is provided that is connected to a drive section. The drive section includes a driving unit, a detection unit that detects rotation of the driving unit and outputs a rotation number detection signal, and a control unit that estimates a remaining amount of toner in view of the accumulated number of times the rotation number detection signal has been output from the detection unit. The toner case includes a main body that contains the toner, a discharge port that is provided in the main body and allows the toner to pass through the discharge port, and a transportation unit that is rotatably provided in the main body that transports the toner toward the discharge port, and is driven by the driving unit.

According to yet another embodiment of the present disclosure, an image forming apparatus is provided that includes a toner case, a drive section, and a control unit. The toner case includes a main body that contains toner, a discharge port that is provided in the main body and allows the toner to pass through the discharge port, and a transportation unit that is rotatably provided in the main body and transports the toner toward the discharge port. The drive section includes a driving unit that drives the transportation unit, and a detection unit that detects rotation of the transportation unit and outputs a rotation number detection signal. The control unit estimates a remaining amount of the toner in the toner case in view of the accumulated number of times the rotation number detection signal has been output from the detection unit.

According to yet another embodiment of the present disclosure, a method of detecting a remaining amount of toner is provided that detects the remaining amount of the toner in a toner case. The toner case includes a transportation unit that is rotated by a driving unit to transport the toner. The method of detecting the remaining amount of toner includes detecting rotation of the transportation unit and outputting a rotation number detection signal, and estimating the amount of the toner remaining in the toner case by comparing the accumulated number of times the rotation number detection signal has been output with a specified threshold value.

Additional features and advantages are described herein, and will be apparent from the following Detailed Description and the figures.

### BRIEF DESCRIPTION OF THE FIGURES

FIG. 1 is a schematic diagram illustrating an outline of the structure of a color printer according to an embodiment of the present disclosure;

FIG. 2 is a perspective view illustrating connection of a toner transportation device to a developing unit in the color printer according to an embodiment of the present disclosure;

FIG. 3 is a plan view of a toner container with the cover of the toner container removed in the color printer according to an embodiment of the present disclosure;

FIG. 4 is a rear view of a gear mechanism located in the toner container in the color printer according to an embodiment of the present disclosure;

FIG. 5 is a perspective view of a container drive section in the color printer according to an embodiment of the present disclosure viewed from the front side;

FIG. 6 is a perspective view of the container drive section in the color printer according to an embodiment of the present disclosure viewed from the rear side;

FIG. 7 is a bottom view of the gear mechanism provided in the container drive section in the color printer according to an embodiment of the present disclosure;

FIG. 8 is a block diagram illustrating the configuration of the color printer according to an embodiment of the present disclosure;

FIG. 9 is a flowchart illustrating a process of estimating the remaining amount of toner in the color printer according to an embodiment of the present disclosure; and

FIG. 10 is a perspective view of a detection unit according to another embodiment.

### DETAILED DESCRIPTION

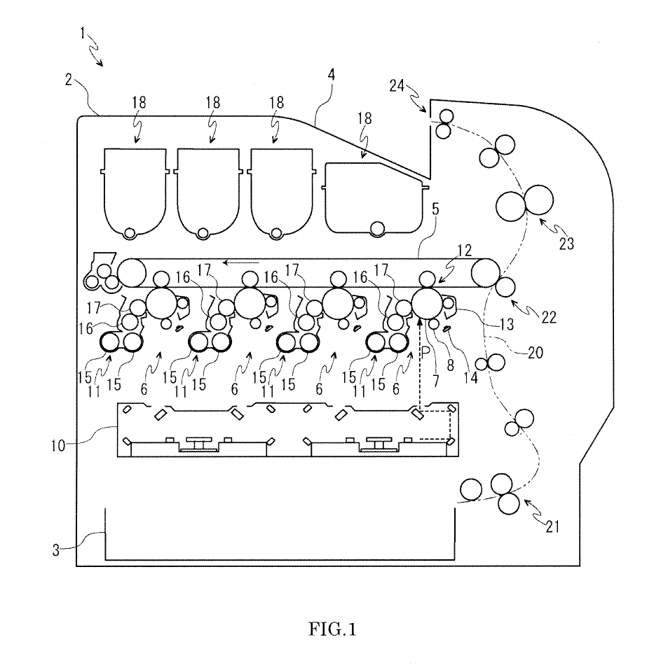

The general structure of a color printer 1 is initially described with reference to FIG. 1. The color printer 1 serves as an image forming apparatus. FIG. 1 is a schematic diagram illustrating an outline of the structure of the color printer according to an embodiment of the present disclosure.

The color printer 1 includes a box-shaped printer main body 2. A sheet feed cassette 3 is located in a lower portion of the printer main body 2. Sheets of transfer paper are loaded in the sheet feed cassette 3. A delivery tray 4 is located in an upper end of the printer main body 2.

An intermediate transfer belt 5 is located at an upper portion of the printer main body 2. The intermediate transfer belt 5, which serves as an image carrying body, is stretched around a plurality of rollers. An exposure unit 10, which includes a laser scanning unit (LSU), is located below the intermediate transfer belt 5. A plurality of image forming units 6 are positioned along a lower portion of the intermediate transfer belt 5. The image forming units 6 are provided for corresponding colors that include, for example, yellow (Y), magenta (M), cyan (C), and black (K). A photoconductor drum 7 is rotatably located in each of the image forming units 6. A charger 8, a developing unit 11, a primary transfer unit 12, a cleaning device 13, and an eraser 14 are located around the photoconductor drum 7 in the order of processes of primary transfer.

A pair of agitating rollers 15 is located at a lower portion of each of the developing unit 11. A magnetic roller 16 is positioned above each pair of the agitating rollers 15, and a developing roller 17 is positioned above each magnetic roller 16. Toner transportation devices 18 are positioned above the developing units 11. The details of the toner transportation devices 18 will be described later.

A transportation path 20, through which a transfer sheet is transported, is found on one side (right side in FIG. 1) of the printer main body 2. Along the transportation path 20, a sheet feed unit 21 is positioned at an upstream end, a secondary transfer unit 22 is positioned at one end (right end in FIG. 1) of the intermediate transfer belt 5 in a midstream, a fixing unit 23 is located downstream, and a sheet delivery port 24 is located at the downstream end.

Next, an image forming operation of the color printer 1 having the above-described structure will be described.

When the power of the color printer 1 is turned on, a variety of parameters are initialized, and initial settings such as a temperature setting of the fixing unit 23 are performed. When image data is inputted to the color printer 1 from a computer, or the like, connected to the color printer 1 and the color printer 1 is instructed to start printing, the image forming operation is performed as follows.

A surface of one of the photoconductor drums 7 is initially charged by the corresponding charger 8. After that, the photoconductor drum 7 is exposed to laser light (see arrow P in FIG. 1) emitted from the exposure unit 10 corresponding to the image data, thereby forming an electrostatic latent image on the surface of the photoconductor drum 7. Next, the developing unit 11 develops the electrostatic latent image to a toner image of a corresponding one of the colors. This toner image undergoes a primary transfer onto a surface of the intermediate transfer belt 5 using the primary transfer unit 12. The image forming units 6 sequentially performs the above-described operation to form a full-color toner image on the intermediate transfer belt 5. Toner and electrical charges remaining on the photoconductor drums 7 are removed by the cleaning device 13 and the eraser 14.

A transfer sheet, picked up by the sheet feed unit 21 from the sheet feed cassette 3 or a manual feed tray (not shown), is transported to the secondary transfer unit 22 at a rate adjusted with respect to the timing of the image forming operation. The full-color toner image on the intermediate transfer belt 5 undergoes a secondary transfer onto the transfer sheet in the secondary transfer unit 22. The transfer sheet onto which the secondary transfer of the toner image has been performed is transported toward the downstream through the transportation path 20 and enters the fixing unit 23. The fixing unit 23 fixes the toner image onto the transfer sheet. The transfer sheet, onto which the toner image has been fixed, is delivered to the delivery tray 4 from the sheet delivery port 24.

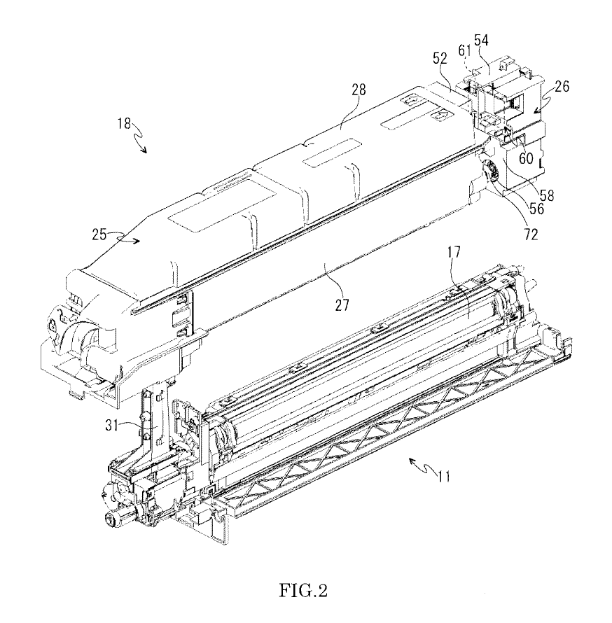

Next, the structure of the toner transportation device 18 will be described with reference to FIGS. 2 to 7. For convenience of explanation, a left front side in FIG. 2 is hereafter referred to as a front surface side of the toner transportation device 18. FIG. 2 is a perspective view illustrating connection of the toner transportation device to the developing unit in the color printer according to an embodiment of the present disclosure.

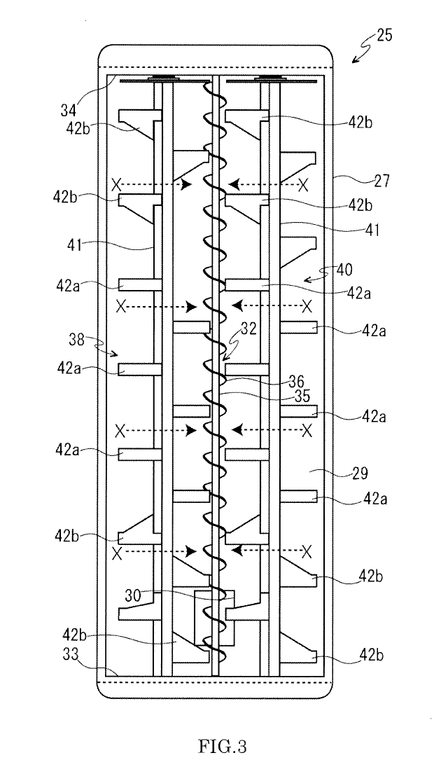

FIG. 3 is a plan view of a toner container with the cover of the toner container removed in the color printer according to an embodiment of the present disclosure.

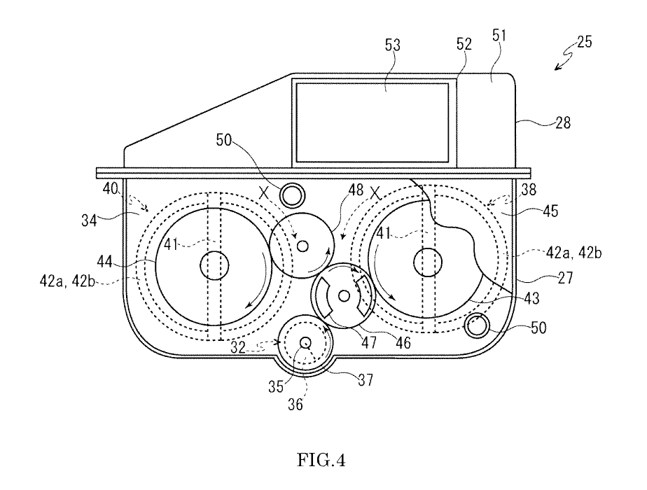

FIG. 4 is a rear view of a gear mechanism positioned in the toner container in the color printer according to an embodiment of the present disclosure.

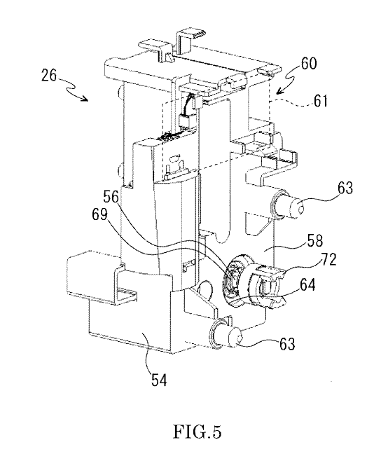

FIG. 5 is a perspective view of a container drive section in the color printer according to an embodiment of the present disclosure viewed from the front side.

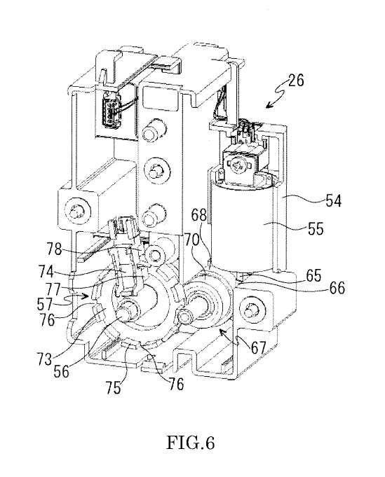

FIG. 6 is a perspective view of the container drive section in the color printer according to an embodiment of the present disclosure viewed from the rear side.

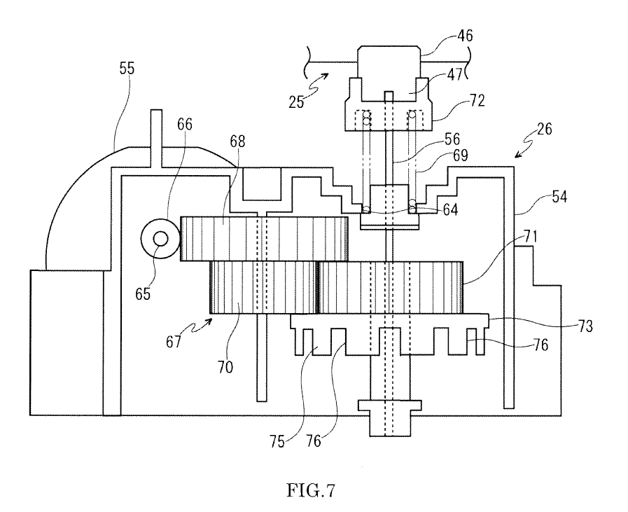

FIG. 7 is a bottom view of the gear mechanism located in the container drive section in the color printer according to an embodiment of the present disclosure.

As illustrated in FIG. 2, each toner transportation device 18 includes a toner container 25 and a container drive section 26. The toner container 25, which serves as a toner case, is provided above a corresponding developing unit 11. The container drive section 26 is connected to one longitudinal end (rear end in the present embodiment) of the toner container 25.

The toner container 25 contains toner. The toner container 25 is removably mounted in a toner container mounting unit (not shown) located in the printer main body 2. The toner container 25 is replaceable, for example, when the toner container 25 runs out of toner.

The toner container 25 includes a main body 27 and a cover 28. The main body 27 has a box shape with an open upper side, and the cover 28 covers the upper side of the main body 27.

As illustrated in FIG. 3, the main body 27 has a bottom wall 29. A discharge port 30 is formed in a front portion of the bottom wall 29. The discharge port 30 is connected to an inner portion of the developing unit 11 through a pipe 31 (see FIG. 2) positioned therebetween in a position substantially vertical to the printer main body 2. When the toner container 25 is not mounted in the printer main body 2, the discharge port 30 is closed by a rotatable shutter (not shown), which is connected to a lever (not shown). Mounting the toner container 25 in the printer main body 2 unlocks the lever. Then, operation of the lever, performed by a user, causes the shutter to rotate, thereby opening the discharge port 30. Although the rotatable shutter is used as described above in an embodiment, a sliding shutter may be used in another embodiment. In this case, mounting the toner container 25 in the printer main body 2 causes the discharge port 30 to be opened.

In the main body 27, a transportation screw 32, which serves as a transportation unit, is rotatably mounted above the discharge port 30. The transportation screw 32 includes a rotation shaft 35, a spiral fin 36, and a transportation gear 37 (see FIG. 4). Longitudinal end portions of the rotation shaft 35 are rotatably supported by front and rear side walls 33 and 34 of the main body 27. The spiral fin 36 is positioned in an outer periphery of the rotation shaft 35 so as to be coaxial with the rotation shaft 35. The transportation gear 37 is located at one of the longitudinal ends (the rear end in the present embodiment) of the rotation shaft 35.

A first agitating paddle 38 and a second agitating paddle 40 are provided in the main body 27. The first agitating paddle 38, which serves as an agitating unit, is rotatably positioned on one side above the transportation screw 32 (the upper left side in the present embodiment). The second agitating paddle 40, which serves as an agitating unit, is rotatably provided on another side above the transportation screw 32 (the upper right side in the present embodiment). Each of the agitating paddles 38 and 40 has a rectangular frame plate-shaped supporting frame 41 positioned in the axial direction. A plurality of spaced-apart semi-circle shaped agitating members 42a and 42b are attached to each supporting frame 41 in the longitudinal directions of the supporting frame 41. The agitating members 42a are located in a central portion in the axial direction of each supporting frame 41. The agitating members 42b are positioned on front and rear sides of each supporting frame 41. The width of each agitating member 42a is substantially uniform. Each agitating member 42b has a reverse-tapered shape, the diameter of which increases in the longitudinal direction of the supporting frame 41 from a central portion toward one of end portions of the supporting frame 41. A first agitating gear 43 is located in a rear end portion of the first agitating paddle 38, and a second agitating gear 44 is located in a rear end portion of the second agitating paddle 40. Although two agitating units are provided in the present embodiment, a structure having a single agitating unit, or a structure in which the transportation screw also functions as the agitating unit, may be used.

As illustrated in FIG. 4, a rear surface cover 45 is mounted on the rear side wall 34 of the main body 27. In FIG. 4, only part of the rear surface cover 45 is illustrated. Near a lower central portion of the rear side wall 34, a first idle gear 46 is positioned. The first idle gear 46 is engaged with the transportation gear 37 and the first agitating gear 43. In the present embodiment, the gear ratio of the first idle gear 46 to the transportation gear 37 is set to 3:2. The first idle gear 46 has a container-side joint 47. A second idle gear 48 is engaged with the first idle gear 46 and the second agitating gear 44. The second idle gear 48 is formed so as to have a size and shape similar to those of the first idle gear 46. The rear side wall 34 of the main body 27 has a pair of cylindrically shaped engaging cylinders 50 located in the upper central portion and the lower left end portion.

The cover 28 is secured to the main body 27 using ultrasonic welding. The cover 28 has a rectangular-shaped protrusion 52 arranged on a rear wall 51 thereof. An integrated circuit (IC) tag 53 (a radio frequency identification (RFID) tag) is attached to the protrusion 52. The details of the IC tag 53 will be described hereinafter.

The container drive section 26 is located in a rear portion of the printer main body 2. The container drive section 26 is removably mounted to the toner container 25. As illustrated in FIGS. 5 and 6, the container drive section 26 includes a frame member 54, a drive motor 55, an output shaft 56, and a detection unit 57. The frame member 54 is an outer frame of the container drive section 26. The drive motor 55, which serves as a driving unit, is secured to the frame member 54 on one side (the left side in the present embodiment) of the frame member 54 in a substantially vertical position. The output shaft 56, disposed in the longitudinal direction, is rotatably supported on the other side (the right side in the present embodiment) of the frame member 54. The detection unit 57 is located on a rear end of the output shaft 56.

A substrate mounting unit 60 is located at a position on a front surface 58 of the frame member 54 corresponding to the position of the protrusion 52 of the toner container 25. A substrate 61 (an RFID substrate) is mounted on this substrate mounting unit 60. When the toner container 25 is mounted in the printer main body 2, the substrate 61 opposes the IC tag 53. The details of the substrate 61 will be described hereinafter. Engaging protrusions 63 are provided at positions on the front surface 58 of the frame member 54 corresponding to the positions of the corresponding engaging cylinders 50 of the toner container 25. When the toner container 25 is mounted in the printer main body 2, the engaging cylinders 50 are engaged with corresponding engaging protrusions 63. An insertion hole 64 is formed in a horizontal direction in a lower central portion of the frame member 54.

The drive motor 55 is a direct-current (DC) brush motor. However, any motor such as a DC brushless motor or a stepping motor may be used as the drive motor 55 instead of a DC brush motor. The drive motor 55 has a motor shaft 65 that extends downwardly, to which a worm 66 is secured. As most clearly illustrated in FIG. 7, the worm 66 is engaged with a large diameter portion 68 of a worm gear 67 rotatably supported by the frame member 54. A small diameter portion 70 of the worm gear 67 is engaged with an output gear 71, which rotates together with the output shaft 56. When the drive motor 55 rotates, the rotation of the drive motor 55 is transmitted to the output shaft 56 through the worm 66, the worm gear 67, and the output gear 71, thereby rotating the output shaft 56.

The output shaft 56 is urged forward by a coil spring 69. A front portion of the output shaft 56 is inserted through the insertion hole 64. A drive section-side joint 72 is located at a front end of the output shaft 56. The drive section-side joint 72 is provided at a position corresponding to the position of the container-side joint 47, which is located in the first idle gear 46 of the toner container 25. Mounting of the toner container 25 in the printer main body 2 causes the container-side joint 47 to engage with the drive section-side joint 72, thereby allowing rotation of the output shaft 56 to be transmitted to the first idle gear 46 of the toner container 25.

As illustrated in FIG. 6, the detection unit 57 includes a pulse plate 73 and a sensor 74. The pulse plate 73 is located on the rear end of the output shaft 56 so as to be rotatable together with the output shaft 56. The sensor 74 is secured to the frame member 54 at a position above the pulse plate 73. The pulse plate 73 is integrated with the output gear 71 (see FIG. 7). A light shielding portion 75 is provided at an outer periphery of the pulse plate 73. The light shielding portion 75 has a rearwardly protruding flange-like shape. The light shielding portion 75 has 12 slits 76 that are equally spaced in a peripheral direction thereof.

The sensor 74 is a photo interrupter sensor (a PI sensor) and includes a light emitter 77 and a light receiver 78. The light emitter 77 is positioned inside the light shielding portion 75 in a radial direction of the pulse plate 73. The light receiver 78 is positioned outside the light shielding portion 75 in the radial direction of the pulse plate 73. The light emitter 77 and the light receiver 78 oppose each other and are positioned on one side and the other side of the light shielding portion 75. When the pulse plate 73 rotates, a detection light path from the light emitter 77 to the light receiver 78 is continuously alternatingly formed and interrupted by the slits 76 and the light shielding portion 75. By counting the formation and interruption cycles, the number of rotations of the pulse plate 73 can be detected. The pulse plate 73 rotates as the transportation screw 32 rotates in an interlocked manner. Accordingly, the number of rotations of the transportation screw 32 can be detected by detecting the number of rotations of the pulse plate 73. The results of this detection are used to estimate the amount of toner remaining in the toner container 25, which will be described hereinafter.

In the present embodiment, since the pulse plate 73 has 12 slits 76, the sensor 74 detects 12 pulses during one rotation of the pulse plate 73. As described above, the gear ratio of the first idle gear 46, which is connected to the output shaft 56, to the transportation gear 37, which is provided to the transportation screw 32, is set to 3:2. Accordingly, while the transportation screw 32 performs one rotation, the output shaft 56 performs two thirds of a rotation, as a result of which the sensor 74 detects eight pulses.

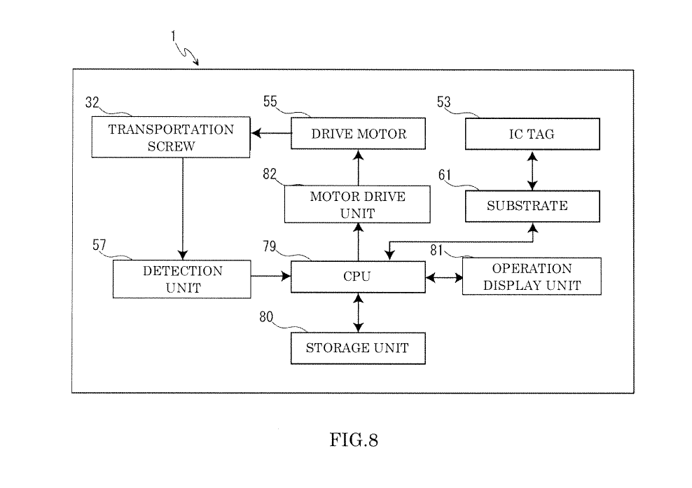

Next, a control system of the color printer 1 will be described with reference to FIG. 8. FIG. 8 is a block diagram illustrating the configuration of the color printer according to an embodiment of the present disclosure.

The color printer 1 includes a central processing unit (CPU) 79, which functions as a control unit. The CPU 79 is connected to a storage unit 80, which includes storage devices such as a read-only memory (ROM) and a random access memory (RAM). The CPU 79 controls each part of the color printer 1 using a control program and control data stored in the storage unit 80.

The CPU 79 is also connected to an operation display unit 81 located in the printer main body 2. The operation display unit 81 includes operation keys such as, for example, a start key, a stop/clear key, a power key, a tenkey, and a touch screen. When the user operates one of the operation keys, a corresponding one of operational instructions is outputted to the CPU 79. The operation display unit 81 displays various information including, for example, error messages and the remaining amount of toner in accordance with signals output from the CPU 79.

The CPU 79 is connected to the above-described detection unit 57. A rotation number detection signal of the transportation screw 32 (simply referred to as “rotation number detection signal” hereafter) detected by the detection unit 57 is outputted from the detection unit 57 to the CPU 79.

The CPU 79 is connected to a motor drive unit 82. A current flows from the motor drive unit 82 to the drive motor 55 in accordance with a drive instruction signal from the CPU 79, thereby rotating the motor shaft 65 of the drive motor 55. The motor drive unit 82 may use, for example, an existing known motor drive circuit that includes transistors and resistors.

The CPU 79 is connected to the substrate 61 (RFID substrate) located in the container drive section 26 as described above. The substrate 61 and the IC tag 53 (RFID tag), which opposes the substrate 61 and is bonded to the toner container 25 as described above, perform wireless communication with each other as follows.

The IC tag 53 includes a non-volatile memory. This memory stores information about the toner container 25 including, for example, the number of rotations of the transportation screw 32, a type number, the date of manufacture, serial number, usage history, and the color of toner. The substrate 61 functions to read the information stored in the memory of the IC tag 53 and output the read information to the CPU 79 in accordance with a signal from the CPU 79. The CPU 79 performs a variety of determinations based on the information about the toner container 25 that is read by the substrate 61. The CPU 79 causes the operation display unit 81 to display the determination result where necessary. For example, the CPU 79 determines whether or not the toner container 25 is a genuine part. The substrate 61 also functions to write various information to the IC tag 53. For example, the substrate 61 writes to the IC tag 53 the number of times the rotation number detection signal has been outputted from the detection unit 57 to the CPU 79. Thus, the substrate 61 functions as a reader/writer that reads from and writes to the IC tag 53.

When a particular toner container 25 is removed from the printer main body 2, the information about the toner container 25 is erased from the CPU 79. However, the non-volatile memory of the IC tag 53 still retains the information about the toner container 25. When the particular toner container 25 is again mounted in the printer main body 2, the information about the toner container 25 retained in the memory of the IC tag 53 is read by the substrate 61 and outputted to the CPU 79, thereby restoring the information about the toner container 25 to the CPU 79.

Next, an operation in which toner is supplied from one of the toner transportation devices 18 to a corresponding one of the developing units 11 in the above-described color printer 1 will be described.

When the image forming operation, as described above, is performed, and accordingly, toner in the developing unit 11 is consumed, the CPU 79 determines whether or not the toner needs to be supplied to the developing unit 11 from the toner container 25. This determination may be performed, for example, based on the amount of toner consumption calculated by the CPU 79 based on the rotation number detection signal received from the detection unit 57. Alternatively, the determination may be performed based on the toner consumption amount calculated by the CPU 79 based on a signal regarding the toner concentration or the amount of toner received from a toner sensor (not shown) provided in the developing unit 11. Alternatively, the determination may be performed based on the toner consumption amount calculated by the CPU 79 based on the number of dots of developed images.

When the CPU 79 determines that toner needs to be supplied to the developing unit 11 as a result of the above-described determination, the CPU 79 outputs a drive instruction signal to the motor drive unit 82 causing a current to flow from the motor drive unit 82 to the drive motor 55, thereby rotating the motor shaft 65 of the drive motor 55. The rotation of the motor shaft 65 is transmitted to the output shaft 56 through the worm 66, the worm gear 67, and the output gear 71, thereby rotating the output shaft 56. The rotation of the output shaft 56 is transmitted to the first idle gear 46 through the drive section-side joint 72 and the container-side joint 47.

By doing this, as illustrated in FIG. 4, the first idle gear 46 rotates in a first direction (clockwise in FIG. 4) as the drive motor 55 rotates. As the first idle gear 46 rotates, the transportation gear 37, which is engaged with the first idle gear 46, rotates in a second direction (counterclockwise in FIG. 4), thereby rotating the transportation screw 32 also in the second direction. As a result, the toner contained in the toner container 25 is transported from the discharge port 30 to the developing unit 11 through the pipe 31. Thus, the toner is supplied to the developing unit 11.

As the above-described first idle gear 46 rotates, the first agitating gear 43, which is engaged with the first idle gear 46, rotates in the second direction, thereby rotating the first agitating paddle 38 also in the second direction. At the same time, the second idle gear 48, which is engaged with the first idle gear 46, rotates in the second direction. This causes the second agitating gear 44, which is engaged with the second idle gear 48, to rotate in the first direction, thereby rotating the second agitating paddle 40 in the first direction. As the agitating paddles 38 and 40 rotate, the toner contained in the toner container 25 is agitated while being transported toward the transportation screw 32 (the directions indicated by dotted arrows).

In an embodiment, as described above, as the first idle gear 46 rotates, the first agitating paddle 38 rotates in the second direction and the second agitating paddle 40 rotates in the first direction. Accordingly, the toner contained in the toner container 25 is gathered between the first agitating paddle 38 and the second agitating paddle 40 while being transported toward the transportation screw 32 (in the dotted arrow X directions). Thus, with the above-described agitating paddles 38 and 40, the toner can be reliably transported toward the transportation screw 32, thereby increasing efficiency in the transportation of the toner.

In addition, when the above-described structure is used, the transportation gear 37, the first agitating gear 43, and the second agitating gear 44 are connected to the drive motor 55 through the first idle gear 46. The use of the first idle gear 46 can increase the freedom with which the transportation screw 32, the first agitating paddle 38, and the second agitating paddle 40 can be arranged. A single type of the container drive sections 26 can be used for a variety of types and sizes toner containers 25 when the size of the first idle gear 46 is uniform despite variations in arrangement and size of the transportation gear 37, the first agitating gear 43, and the second agitating gear 44. This allows the manufacturing process to be simplified and the manufacturing cost to be reduced.

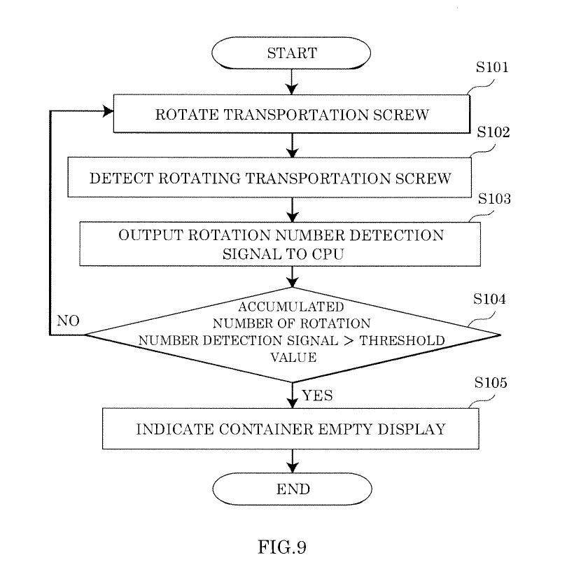

Next, a method of estimating the remaining amount of the toner in the toner container 25 using CPU 79 will be described with reference mainly to FIG. 9. FIG. 9 is a flowchart illustrating a process of estimating the remaining amount of toner in the color printer 1 according to an embodiment of the present disclosure.

As described above, when supply of the toner from the toner container 25 to the developing unit 11 is started, rotation of the drive motor 55 is transmitted to the transportation screw 32, thereby rotating the transportation screw 32 (S101). As the transportation screw 32 rotates, the pulse plate 73 located on the output shaft 56 also rotates in an interlocked manner. The rotation of the pulse plate 73 causes the light shielding portion 75 and the slits 76 to interrupt and faun the detection light path from the light emitter 77 to the light receiver 78. By detecting formation and interruption of the detection light path using the sensor 74, rotation of the transportation screw 32 is detected using the detection unit 57 (S102). In an embodiment, as described above, eight pulses is equal to one rotation of the transportation screw 32. Thus, the sensor 74 detects a pulse every one-eighth of a rotation of the transportation screw 32.

Upon detecting rotation of the transportation screw 32, the detection unit 57 outputs the rotation number detection signal to the CPU 79 (S103). The CPU 79 estimates the remaining amount of the toner in the toner container 25 based on the number of times the rotation number detection signal has been outputted. As an example, a situation wherein the toner container 25 contains 2 kg of toner and runs out of the toner when the number of rotations of the transportation screw 32 reaches 40,000 will be described.

In an embodiment, as described above, one rotation of the transportation screw 32 is equal to eight pulses. Thus, 40,000 rotations of the transportation screw 32 is equal to 320,000 pulses. The number 320,000 times is stored as a threshold value in, for example, the memory of the IC tag 53, the storage unit 80, or other storage unit. When the rotation number detection signal is outputted from the detection unit 57, the CPU 79 compares the accumulated number of times the rotation number detection signal has been outputted to the above-described threshold value to determine if the accumulated number of times the rotation number detection signal has been outputted exceeds the threshold value (S104). As a result of this determination, if the CPU 79 has determined that the accumulated number of times the rotation number detection signal has been outputted does not exceed the threshold value, the CPU 79 estimates that the remaining amount of the toner has not reached zero. Accordingly, steps S101 to S104 are repeated.

As a result of this determination, if the CPU 79 determines that the accumulated number of times the rotation number detection signal has been outputted exceeds the threshold value, the CPU 79 estimates that the remaining amount of the toner has reached zero and outputs the determination result to the operation display unit 81. The operation display unit 81, to which the determination result has been outputted, indicates a container empty display that is, for example, a message indicating that the toner container contains no toner, no toner remains, or the toner container should be replaced, thereby prompting the user to replace the toner container 25 (S105).

In an embodiment, as described above, the detection unit 57, that detects rotation of the transportation screw 32, is located in the toner transportation device 18. Accordingly, the amount of toner remaining in the toner container 25 can be estimated while effects of variation in magnetic force, contamination of the toner container 25, and the like are avoided. Thus, compared to the situation wherein a magnetic permeability sensor or an optical sensor is used to detect magnetic permeability or light transmittance in the toner container 25, the probability of detection errors occurring can be decreased. In addition, the detection unit 57 can be used regardless of whether the toner is magnetic toner or non-magnetic toner. This can increase the range of use of the toner transportation device 18. Since the amount of toner remaining in the toner container 25 is estimated based on the number of rotations of the transportation screw 32, the amount of toner remaining can be more reliably estimated compared to the situation wherein the amount of toner remaining is estimated based on the number of dots in developed images. Since the number of rotations of the transportation screw 32 is detected, the reliability of rotation detection can be increased compared to the situation wherein rotation time of the transportation screw 32 is detected.

Since the above-described detection unit 57 includes the pulse plate 73 and the sensor 74, the number of rotation of the transportation screw 32 can be more reliably detected using a simple structure. Compared to the situation wherein sensor light emitted from the light emitter 77 passes through the toner container 25 to reach the light receiver 78, the distance between the light emitter 77 and the light receiver 78 can be decreased. This can further decrease the occurrence of detection errors.

In an embodiment, the detection unit 57 is positioned in the container drive section 26 that is removably mounted to the toner container 25. Thus, the toner container 25 does not need to have the detection unit 57. As a result, a complex structure for the toner container can be avoided. In addition, the number of rotations of the transportation screw 32 can be detected using an existing known toner container.

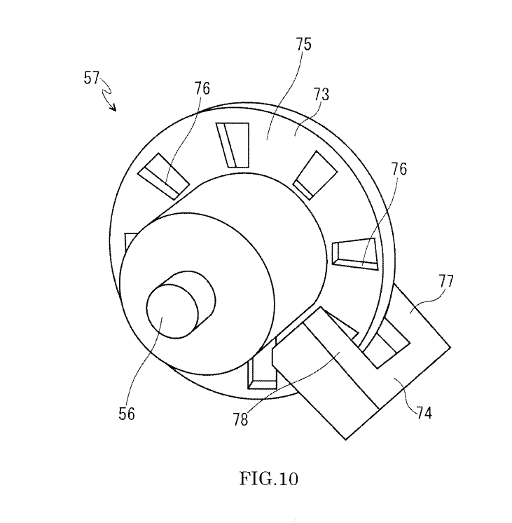

In an embodiment, the light shielding portion 75 having a flange-like shape is positioned at the outer periphery of the pulse plate 73, and the light emitter 77 and the light receiver 78 of the sensor 74 are disposed inside and outside the light shielding portion 75 in the radial direction of the pulse plate 73. In another embodiment, as illustrated in FIG. 10, an outer diameter area of the pulse plate 73 can serve as the light shielding portion 75, and the light emitter 77 and the light receiver 78 of the sensor 74 can be disposed on one side and the other side of the pulse plate 73 in the width direction of the pulse plate 73. As described above, the shape of the pulse plate 73 and arrangement of the sensor 74 may be modified as appropriate in accordance with the layout of a product and the like.

Although 12 slits 76 are formed in the pulse plate 73 in an embodiment, as illustrated in FIG. 10, eight slits 76 may be formed in the pulse plate 73 in another embodiment. As described above, the number of slits 76 may be changed where appropriate based on the speed reduction ratio of gears that connect the transportation screw 32 to the pulse plate 73, required detection accuracy, or the like.

Although the pulse plate 73 is coaxial with the output shaft 56 in an embodiment, the pulse plate 73 may be coaxial with the transportation screw 32 or a different shaft in another embodiment. That is, the pulse plate 73 may be disposed at any position in a rotation transmission mechanism from the drive motor 55 to the transportation screw 32. Although the detection unit 57 including the pulse plate 73 and the sensor 74 is used in an embodiment, the detection unit 57 may include a magnetic rotary encoder, a mechanical rotary encoder, or the like in another embodiment.

Although the transportation unit uses the transportation screw 32 in an embodiment, the transportation unit may use a roller-shaped member in another embodiment. Although the agitating unit uses the agitating paddle in an embodiment, the agitating unit may use a screw-shaped member in another embodiment.

Although the toner container 25 is connected to the developing unit 11 through the toner pipe 31 in an embodiment, the toner container 25 may be directly removably attached to the developing unit 11 in another embodiment.

In an embodiment, when no toner remains in the toner container 25, the CPU 79 causes the operation display unit 81 to indicate the container empty display. In another embodiment, in addition to the above-described container empty display, the CPU 79 may cause the operation display unit 81 to indicate, when the remaining amount of the toner in the toner container 25 is small (for example, 100 g), a nearly empty display message indicating that only the small amount of toner remains in the toner container.

The remaining amount of the toner in the toner container 25 may be estimated based on the ratio of the accumulated number of times the rotation number detection signal has been outputted to the threshold value of the number of times the rotation number detection signal has been outputted. Assume that, for example, as in an embodiment, the threshold value of the number of times the rotation number detection signal has been outputted stored in the storage unit is 320,000, which indicates the situation where the toner container 25 runs out of toner. When the accumulated number of times the rotation number detection signal has been outputted reaches 80,000, 160,000, and 240,000, the CPU 79 can estimate that one fourth, a half, and three fourths of the toner is consumed, and cause the operation display unit 81 to display 75%, 50%, and 25% as the remaining amount of toner corresponding to the respective accumulated numbers of times the rotation number detection signal has been outputted.

Threshold values of the number of times the rotation number detection signal has been outputted corresponding to levels of the remaining amount of the toner in the toner container 25 may be stored in the storage unit such as the storage unit 80 or the memory of the IC tag 53. In this situation, every time the number of times the rotation number detection signal has been outputted reaches the threshold value corresponding to one of the levels, the CPU 79 can transmit a signal to the operation display unit 81 to cause the operation display unit 81 to display the remaining amount of the toner in a step-by-step manner. Assume that, for example, the number of times the rotation number detection signal has been outputted indicating that the toner container 25 has run out of the toner is set to 320,000 as in the present embodiment. In this situation, by storing the threshold values 80,000, 160,000, 240,000, and 320,000 in the storage unit, four levels of the remaining amount of toner can be indicated that corresponds to these threshold values.

In an embodiment, the present disclosure is applied to the tandem color printer 1. In other embodiments, the present disclosure may be applicable to rotary color printers, monochrome printers, copying machines, digital multi-function peripherals, facsimile machines, and other image forming apparatuses.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A toner transportation device comprising:
a toner case including
a main body that contains toner,
a discharge port located in the main body, through which the toner is discharged, and
a transportation unit rotatably positioned in the main body, the transportation unit transporting the toner toward the discharge port; and
a drive section including
a driving unit that drives the transportation unit,
a detection unit that detects rotation of the transportation unit and outputs a rotation number detection signal, and
a control unit that estimates a remaining amount of the toner in the toner case based on an accumulated number of times the rotation number detection signal has been outputted from the detection unit.

2. The toner transportation device according to claim 1,
wherein the detection unit includes
a pulse plate having a light shielding portion, the light shielding portion having a plurality of slits arranged in a peripheral direction of the light shielding portion, the pulse plate rotating together with the transportation unit, and
a sensor that includes a light emitter and a light receiver, the light emitter and the light receiver opposing each other and being located on one side and the other side of the light shielding portion of the pulse plate.

3. The toner transportation device according to claim 1,
wherein the toner case includes
a transportation gear in the transportation unit,
at least one agitating unit rotatably positioned above the transportation unit,
an agitating gear in the agitating unit, and
an idle gear engaged with the transportation gear and the agitating gear,
the idle gear rotates along with rotation of the driving unit.

4. The toner transportation device according to claim 1,
wherein the toner case includes an IC tag, and
the drive section includes a substrate disposed at a position opposite the IC tag.

5. The toner transportation device according to claim 4,
wherein the IC tag includes a non-volatile memory, and
the non-volatile memory stores information relating to the number of rotations of the transportation unit.

6. The toner transportation device according to claim 5,
wherein the substrate is a radio frequency identification substrate that can read information stored in the non-volatile memory and write to the IC tag the number of times the rotation number detection signal has been outputted from the detection unit to the control unit.

7. A toner case that is connected to a drive section and that includes a driving unit, a detection unit that detects rotation of the driving unit and outputs a rotation number detection signal, and a control unit that estimates a remaining amount of toner based on an accumulated number of times a rotation number detection signal has been outputted from the detection unit, the toner case comprising:
a main body that contains toner;
a discharge port located in the main body through which the toner is discharged; and
a transportation unit rotatably positioned in the main body, the transportation unit transporting the toner toward the discharge port, the transportation unit being driven by the driving unit.

8. An image forming apparatus comprising:
a toner case that includes
a main body that contains toner,
a discharge port located in the main body through which the toner is discharged, and
a transportation unit rotatably positioned in the main body, the transportation unit transporting the toner toward the discharge port;
a drive section that includes
a driving unit that drives the transportation unit, and
a detection unit that detects rotation of the transportation unit and outputs a rotation number detection signal; and
a control unit that estimates a remaining amount of the toner in the toner case based on an accumulated number of times the rotation number detection signal has been outputted from the detection unit.

9. The image forming apparatus according to claim 8, comprising:
an operation display unit connected to the control unit; and
a storage unit connected to the control unit, the storage unit storing as a threshold value the number of times the rotation number detection signal has been outputted, the threshold value indicating a situation wherein no toner remains in the toner case,
when the rotation number detection signal is outputted from the detection unit, the control unit compares the accumulated number of times the rotation number detection signal has been outputted to the threshold value stored in the storage unit, the control unit causing the operation display unit to indicate that there is no toner remaining in the toner case when the control unit determines that the accumulated number of times the rotation number detection signal has been outputted exceeds the threshold value stored in the storage unit.

10. The image forming apparatus according to claim 9,
wherein, when the control unit determines that there is a small amount of the toner remaining in the toner case, the control unit causes the operation display unit to indicate that a small amount of the toner remains in the toner case.

11. The image forming apparatus according to claim 9,
wherein the storage unit stores a plurality of the threshold values that are different from each other, the plurality of threshold values being set in a step-by-step manner, and
the control unit causes the operation display unit to indicate the remaining amount of the toner every time the accumulated number of times the rotation number detection signal has been outputted reaches one of the plurality of threshold values.

12. The image forming apparatus according to claim 8,
wherein the toner case includes an IC tag, and
the drive section includes a substrate disposed at a position opposite the IC tag.

13. The image forming apparatus according to claim 12,
wherein the IC tag includes a non-volatile memory, and
the memory stores information about the number of rotations of the transportation unit.

14. The image forming apparatus according to claim 13,
wherein the substrate is a radio frequency identification substrate that can read information stored in the memory and write to the IC tag the number of times the rotation number detection signal has been outputted from the detection unit to the control unit.

15. A method of detecting a remaining amount of toner in a toner case that includes a transportation unit rotated by a driving unit to transport the toner, the method comprising;
detecting rotation of the transportation unit and outputting a rotation number detection signal; and
estimating the remaining amount of the toner in the toner case by comparing an accumulated number of times the rotation number detection signal has been outputted to a specified threshold value.

16. The method according to claim 15, comprising:
issuing a notification indicating that there is no toner remaining in the toner case when no toner is estimated to remain in the toner case.

17. The method according to claim 16, comprising:
issuing a notification indicating that a small amount of the toner remains in the toner case when a small amount of the toner is estimated to remain in the toner case.

18. The method according to claim 15, comprising:
issuing a notification regarding the remaining amount of the toner in the toner case in a step-by-step manner.
